(19) United States
(12) Patent Application Publication
(10) Pub. No.: US 2011/0163006 A1
(43) Pub. Date: Jul. 7, 2011

(54) CRACKING PROCESS AND ENHANCED CATALYSTS FOR SAID PROCESS

(75) Inventors: Giuseppe Bellussi, Piacenza (IT); Roberto Millini, Cerro al Lambro (Milano) (IT); Caterina Rizzo, San Donato Milanese (Milano) (IT); Daniele Colombo, Mezzago (Milano) (IT)

(73) Assignee: ENI S.P.A, Roma (IT)

(21) Appl. No.: 12/996,470

(22) PCT Filed: May 28, 2009
(86) PCT No.: PCT/IB09/05786

§ 371 Date: Mar. 23, 2011

(30) Foreign Application Priority Data
Jun. 6, 2008 (IT) MI2008A001036

(51) Int. Cl. C10G 11/02; C10G 11/04; C10G 11/05; B01J 29/06; B01J 29/18

(52) U.S. Cl. 208/120.01; 208/120.1; 208/120.25; 502/60; 502/64; 502/67

(57) ABSTRACT

The present invention concerns a new cracking process, preferably a fluid catalytic process, characterized in that it is carried out in the presence of a catalyst containing ERS-10 zeolite. The invention also relates to a new catalytic composition containing said ERS-10 zeolite, which can be used as catalyst in catalytic cracking processes, in particular in fluid catalytic cracking processes (FCC).

The present invention concerns a new cracking process, preferably a fluid catalytic cracking, characterized in that it is carried out in the presence of a catalyst containing ERS-10 zeolite.

The invention also relates to a new catalytic composition, containing said ERS-10 zeolite, which can be used as catalyst in catalytic cracking processes, in particular in fluid catalytic cracking processes (FCC).

It is known that the refinery industry adopts FCC processes for converting heavy oil fractions to lighter products. The catalysts used in FCC processes can be either amorphous or crystalline, of a zeolitic or non-zeolitic nature. Amorphous materials, which can be used, are described, for example, in EP 1011291, whereas crystalline materials of non-zeolitic nature are described in U.S. Pat. No. 4,309,279. Catalysts of zeolitic nature, such as, for example, Y zeolite, A zeolite, X zeolite, ZK-5 zeolite, ZK-4 zeolite, mordenite, however, are preferably used.

Among these, zeolite Y is the most widely-used for the cracking of heavy fractions such as vacuum gas oil (VGO) or residues. In this respect, various catalysts based on this zeolite have been described. U.S. Pat. No. 3,140,249, for example, describes a catalyst based on zeolite Y in the form of spheroidal particles with various binders, such as silica, silica-alumina, silica-zirconia, silica-alumina-zirconia. U.S. Pat. No. 3,352,796 describes a zeolite Y-based catalyst, formed by spray-drying with silica as binder. U.S. Pat. No. 3,647,718, U.S. Pat. No. 4,493,902 and U.S. Pat. No. 4,581,341 describe catalysts based on zeolite Y exchanged and bound in the form of microspheres with kaolin.

It is also well-known that additives able to modify the characteristics of products in terms, for example, of the octane number of gasoline, or the fraction of light olefins (propylene and butene) can be added to FCC catalysts. These additives, normally added in a low percentage, often also consist of a zeolite, where said zeolite however must have porosity characteristics different from those of zeolite Y. In particular, the most widely-used zeolite for this purpose is ZSM-5. In U.S. Pat. No. 3,758,403, for example, zeolite ZSM-5 is a component of the catalyst containing zeolite Y exchanged with rare earths in a matrix of silica, alumina or zirconia and a clay. In U.S. Pat. No. 3,894,931 ZSM-5 is used as an additive of the catalyst based on zeolite Y to increase the octane number of the gasoline. U.S. Pat. No. 3,894,933 describes a catalyst based on amorphous silica alumina, zeolite Y or mixtures, in combination with ZSM-5 and/or mordenite as additive in processes for LCO production. A catalyst based on ultra-stabilized zeolite Y, a zeolite with small pores of the ZSM-type (ZSM-5), an inorganic oxidic matrix (alumina, zirconia, titania, magnesia or mixtures thereof) and an inert, porous component (alumina, silica alumina) is described in U.S. Pat. No. 4,289,606. U.S. Pat. No. 4,309,279 and U.S. Pat. No. 4,309,280 describe a conventional catalyst based on amorphous silica alumina, at least one zeolite selected from X, Y or natural faujasite, and with an additive consisting of a zeolite selected from ZSM-5, ZSM-11, ZSM-12, ZSM-23, ZSM-35 o ZSM-38, preferably ZSM-5. In U.S. Pat. No. 4,368,114, a system for increasing the octane number and the gasoline yield uses a catalyst based on amorphous silica alumina, at least one zeolite selected from X, Y or natural faujasite and an additive consisting of a zeolite selected from ZSM-5, ZSM-11, ZSM-12, ZSM-23, ZSM-35 o ZSM-38, preferably ZSM-5 with SAR≧12.

Additives different from zeolites, mainly inorganic phosphates, are also described.

The function of these additives is mainly to increase the octane number of the gasoline fraction and, in some cases, to favour the formation of light olefins, which represent valuable intermediates in the petrochemical industry.

As the request for fuels is continuously increasing and, particularly in Europe, the request for diesel fuels is increasing, the increase in the diesel/gasoline ratio on the part of the market represents a problem for refineries which, until a few years ago favoured conversion to gasoline, mainly through investments and by increasing the capacity of fluid catalytic cracking units.

It consequently became important to maximize the performances of conversion processes of heavy fractions to light distillates, possibly increasing the diesel/gasoline ratio.

In order to meet the evolution of this demand it would be useful to find management procedures of FCC units which would allow heavy fractions (VGO, residues) to be processed with less severity in order to safeguard the yield to diesel, in any case ensuring a high conversion of the heaviest products (bottom cracking) without increasing the yield to HCO. The reduced severity, with the other conditions unchanged, does in fact increase the production of middle distillates, for example LCO, but also causes an undesired increase in heavier products (HCO). In order to limit this drawback, it would be useful to identify an additive for FCC catalysts, which, under the operating conditions, would be able to carry out a controlled cracking to convert HCO into light and middle distillates, without excessively jeopardizing yields to the fractions of interest. This additive would be able to convert the heaviest fraction without causing over-cracking which would increase the gas and coke fraction formed.

The Applicant has unexpectedly found that by using ERS-10 zeolite as additive in cracking processes of hydrocarbon mixtures and preferably fluid catalytic cracking, favorable results are obtained in terms of conversion with an increase of up to 10-15% with respect to the results obtainable with traditional catalytic systems, showing optimum performances also in the conversion of the heaviest fraction (bottom cracking) expressed as the ratio between LCO and HCO, with a reduced production of HCO even up to 50% with respect to the known processes. The increase in the bottom cracking, therefore, implies a significant decrease in the yields to HCO (therefore of fuel oil) and a relative increase in the amount of LCO.

The present invention therefore relates to a process for the cracking of hydrocarbon mixtures, preferably fluid catalytic cracking, characterized in that it is carried out in the presence of a catalyst containing ERS-10 zeolite.

In particular, an object of the present invention relates to a process for the cracking of hydrocarbon mixtures, preferably fluid catalytic cracking, characterized in that it is carried out in the presence of a catalyst containing two different components: (a) a component containing one or more cracking catalysts, preferably fluid catalytic cracking, and (b) a component containing ERS-10 zeolite.

In agreement with this, for the cracking process of the present invention, a new catalyst can be used for the catalytic cracking of hydrocarbons, in particular fluid catalytic cracking (FCC) comprising:

a) a first component containing one or more catalysts selected from zeolites, amorphous cracking catalysts based on inorganic oxides and crystalline non-zeolitic cracking catalysts based on inorganic oxides

b) a second component containing an ERS-10 zeolite.

This catalyst is new and represents a further aspect of the present invention. In this catalyst, the component (a), containing one or more catalysts for catalytic cracking, preferably fluid catalytic cracking, is combined with component (b) having the function of additive.

The catalyst or mixture of catalysts contained in component (a) are preferably dispersed in a matrix of inorganic oxide. The dispersion is carried out according to techniques known to experts in the field.

Examples of amorphous materials which can be used, as described in EP 1011291, are, for example, clays, silico-alumina, silico-magnesia, silico-zirconia, silico-titania, silico-alumina-magnesia, silico-alumina-zirconia, silico-magnesia-zirconia. As non-zeolitic crystalline material, a crystalline silico-alumina can be used, as described, for example, in U.S. Pat. No. 4,309,279.

A preferred aspect of the present invention is the use of a zeolite as component (a), even more preferably a large-pore zeolite.

Zeolites which can be well-used for this purpose are zeolite Y (U.S. Pat. No. 3,130,007), zeolite L (U.S. Pat. No. 3,216,789), zeolite Omega (Cryst. Struct. Comm. 3, 339-344 (1974)), zeolite Beta (U.S. Pat. No. 3,308,069) and Mordenite (Z. Kristallogr., 115, 439-450 (1961)). The same ERS-10 zeolite can be used in component (a) as cracking catalyst, in a mixture with at least another cracking catalyst.

Y zeolites which can be used are those exchanged with hydrogen and/or rare earths or those subjected to thermal treatment by means of techniques which are well-known to experts in the field.

Examples of zeolites which can be typically used as catalyst components are described in:
“Paul B. Venuto, E. Thomas Habib, Jr “Fluid Catalytic Cracking with Zeolite Catalysts” vol. 1, M. Dekker, Inc.;
Julius Scherzer, “Octane-Enhancing Zeolitic FCC Catalysts”, M. Dekker Inc.

The zeolites used as component (a) can be used in bound form with a binder, selected, for example, from silica, alumina, silico-alumina, clay, silico-zirconia, silico-magnesia, aluminium phosphate or mixtures thereof. The preparation of the bound form of the zeolite is carried out according to techniques known to experts in the field.

Component (b) of the catalytic composition of the present invention contains zeolite ERS-10, wherein said zeolite has the function of additive.

This zeolite was described for the first time in EP 796,821, and is also clearly described in:
S. Zanardi, G. Cruciani, L. C. Carluccio, G. Bellussi, C. Perego, R. Millini, “Framework topology of ERS-10 zeolite”, Angew. Chem. Int. Ed., 41(21) (2002) 4109-4112.
C. Perego, M. Margotti, L. C. Carluccio, L. Zanibelli, G. Bellussi, “The catalytic performances of zeolite ERS-10”, Stud. Surf. Sci. Catal., 135 (2001) 29-O-01.
S. Zanardi, G. Cruciani, L. C. Carluccio, G. Bellussi, C. Perego, R. Millini, “Synthesis and framework topology of the new disordered ERS-10 zeolite”, J. Porous Mater., 14 (2007) 315-323.

The preparation of ERS-10 zeolite is clearly described in EP 796821. The synthesis is preferably carried out by heating a reaction mixture containing 6-azonia-spiro-[5,5]-undecane-hydroxide (Q) as organic additive, tetraethylorthosilicate (TEOS) and aluminium isopropoxide (AiP) as sources of silica and aluminium, respectively, sodium hydroxide (NaOH) and water, to a temperature of between 150 and 180° C., preferably from 155 to 170° C., for a period of 7-28 days, preferably for 7-14 days, under autogenous pressure, in a stainless steel autoclave, preferably in the following molar ratios:

| | |
|---|---|
| SiO₂/Al₂O₃ | from 50/1 to ∞ |
| Na⁺/SiO₂ | from 0.05/1 to 0.15/1 |
| Q/SiO₂ | from 0.2/1 to 0.3/1 |
| H₂O/SiO₂ | from 40/1 to 50/1 |
| OH⁻/SiO₂ | from 0.25/1 to 0.45/1 |

The resulting crystalline material is dried at a maximum temperature of 170° C. preferably between 90 and 120° C., and calcined at a temperature ranging from 500 to 700° C. preferably from 550 to 650° C., for a period of time ranging from 4 to 20 hours, preferably between 6 and 15 hours.

From a structural point of view, it has been experimentally demonstrated that the alumino-silicate lattice of ERS-10 is disordered, as it can be described as an intergrowth of three structurally correlated zeolites: Nonasil (NON, zeolite of the clathrasil-type characterized by the presence of cages only, non-connected with the exterior of the crystals), EU-1 (EUO, a medium-pore zeolite characterized by a mono-dimensional system of channels with openings formed by ten tetrahedra (10MR) with large side pockets) and NU-87 (NES, a medium-pore zeolite characterized by a mono-dimensional system of channels with openings formed by ten tetrahedra (10MR)). More specifically, the structure of ERS-10 can be constructed using two periodic units (known as Periodic Building Units, PerBU). The random combination of these periodic units causes the formation, within the same zeolite crystal, of domains having the characteristics of the three zeolites mentioned above (NON, EUO and NES) as well as the presence of a further structural situation characterized by the presence of pores with openings formed by fourteen tetrahedra (14MR). Consequently, typical characteristics of medium-pore zeolites (10MR) and extra large-pore zeolites (14MR) coexist in the same structure.

ERS-10 zeolite crystallizes, in pure form, from reagent mixtures with an SiO₂/Al₂O₃ (SAR) molar ratio included within the range of 80-160, which is therefore preferred.

The crystalline products undergo enrichment in Al for SARs ranging from 60 to 80: operating with reaction mixtures with SAR<80, the co-crystallization of Mordenite (MOR) can be obtained.

With SAR>160, zeolite ZSM-12 (MTW) can be formed. As the ERS-10 zeolite is the result of an intergrowth of several zeolite phases, this implies a variability in their relative ratio or, technically speaking, of the probability of the stacking of the periodic units. As a consequence, the products obtained can have different characteristics in terms of relative abundance of the domains corresponding to the three structures NON, EUO and NES and of channels with 14MR openings.

In the use of ERS-10 zeolite as component of the new catalytic composition for the cracking of hydrocarbon mixtures, in particular FCC, the fact that this is the result of an intergrowth of various phases, in a variable ratio, does not influence its catalytic performances, just as these are also not influenced by the presence of small quantities of Mordenite or zeolite ZSM-12, possibly formed during the synthesis of the zeolite ERS-10, preferably in a quantity not exceeding 30% by weight with respect to the weight of the ERS-10 zeolite.

Analogously, the possible formation of accessory phases of NON, EUO, and NES zeolites, in a small quantity, preferably not higher than 30% by weight with respect to the weight of the ERS-10 zeolite, does not significantly influence the performances of the catalyst.

For application as additive for FCC, ERS-10 can be used in various bound forms, prepared according to techniques known to experts in the field, such as, for example, granulates or, preferably, microspheres. The microspheres can be prepared via spray-drying using the known techniques, and contain the zeolite in a bound form. Silica, amorphous silica-alumina, alumina or mixtures thereof are preferably used as binders.

In component (b), the zeolite, when in a form bound with a binder, is preferably in a quantity of 5 to 90% with respect to the overall weight of said component.

In the composition of the present invention, the ERS-10 zeolite is preferably present in a quantity ranging from 1 to 10% with respect to the weight of the catalyst contained in component (a).

The catalytic composition can be prepared by the mechanical mixing of components (a) and (b), according to techniques known to experts in the field, or by subjecting the ERS-10 zeolite and the catalyst contained in component (a) to contemporaneous binding, according to the known techniques, or it can be prepared in situ by adding component (b) to component (a) already present in the cracking process, in any point of the process itself.

The use of ERS-10 zeolite as cracking additive, preferably fluid catalytic cracking, allows a higher conversion of the FCC feedstock to be obtained, in particular a high bottom cracking with the prevalent formation of the LCO fraction, diesel, with respect to the formation of the HCO fraction.

The conditions under which the cracking process is carried out, preferably fluid catalytic cracking, are well known to experts in the field.

Preferred process temperatures are those ranging from 400 to 650° C., whereas the pressure preferably ranges from 1 to 5 bar.

The process can operate in continuous or batchwise, with a fixed bed, moving bed or fluid bed. The flow of the hydrocarbon mixture can be fed either in current or counter-current with respect to the flow of the catalyst. A particularly preferred aspect of the invention is to use the new catalytic composition in fluid cracking processes.

Suitable hydrocarbons mixtures to be treated according to process of the present invention, are, for example, oil fractions consisting of VGO (Vacuum Gas Oil) having a boiling range of 350 to 550° C., atmospheric residues, deasphalted oils. The products obtained from the fluid catalytic cracking process of the present invention, are listed the following: Fuel Gas (H2, C1-C2); LPG (C3-C4); Gasoline (C5-221); LCO (221-350); HCO (350+).

The following examples are provided for the sole purpose of further clarifying the invention, without limiting the contents in any way.

### Example 1

### Preparation of the ERS-10 Zeolite

The ERS-10 zeolite is synthesized according to example 1 of patent EP798821. 10.4 g of tetraethylorthosilicate (TEOS) are added, at room temperature and under vigorous stirring, to a solution consisting of 45 g of demineralized water, 0.204 g of aluminium isopropylate, 0.19 g of sodium hydroxide and 1.71 g of 6-azonia-spiro-[5,5]-undecane hydroxide (Q). At the end of the hydrolysis of TEOS an opalescent solution is obtained, having the following composition expressed as molar ratios:

SiO₂/Al₂O₃=100/1

Na⁺/SiO₂=0.095/1

Q/SiO₂=0.2/1

H₂O/SiO₂=50/1

OH⁻/SiO₂=0.295/1

Said solution is charged into a stainless steel autoclave, placed in an oven and maintained at 170° C., under autogenous pressure, for 14 days. At the end of the heating, the autoclave is cooled to room temperature obtaining a milky suspension. An aliquot of said suspension, called suspension A, is used in the following example 2, to prepare ERS-10 zeolite in a bound form. In the remaining aliquot of suspension, the crystalline product is separated from the mother liquor by filtration, repeatedly washed with demineralized water and finally dried in an oven at 120° C. for 2 hours.

The composition of the crystalline product, determined with the usual elementary chemical analysis procedures, is the following:

67 SiO₂:1 Al₂O₃:0.5 Q₂O:0.3 Na₂O:0.7 H₂O

The crystalline product is calcined at 550° C. for 5 hours under an air flow and subsequently exchanged into acidic form by means of repeated treatment with a solution of ammonium acetate at 80° C., repeatedly washed with demineralized water and finally calcined at 550° C. for 5 hours.

The composition of the crystalline product thus treated, determined with the usual elementary chemical analysis procedures, is the following:

67 SiO₂:1Al₂O₃

### Example 2

### Preparation of the ERS-10 Zeolite in Bound Form

The preparation of the zeolite ERS-10 in bound form with silica is carried out by spray drying.

124 g of an aqueous solution of tetrapropyl ammonium hydroxide (TPA-OH at 40% by weight and without alkaline or alkaline-earth metals) and 563 g of tetraethylorthosilicate (TEOS) are added in sequence to 655 g of demineralized water contained in a flask equipped with a condenser. The mixture obtained is heated to 60° C. and kept under stirring for 1 hour, obtaining a fluid homogeneous gel having the following molar composition: TPAOH/SiO₂=0.09, H₂O/SiO₂=15.

A mixture is then prepared containing 30% by weight of said gel and 70% by weight (both calculated as SiO₂) of suspension A of ERS-10, prepared in accordance with Example 1. 4% by weight of polyvinyl alcohol (PVA) is added to this mixture; the resulting mixture is heated to 70° C. for 3 hours and subsequently left in aging at room temperature, for 15 hours.

The mixture is then pumped to a pressure nozzle of a Niro-Mobile HI-TEC spray drier programmed with an outlet temperature of 100° C. The product obtained is subsequently calcined in air at 550° C. for 5 hours. Tests by mean of a scanning electron microscope (SEM) demonstrate that the sample consists of spherical particles with a diameter within the range of 50-120 micrometers.

### Example 3

### Catalytic Test

The following tests have been performed adopting a fixed bed micro-reactor utilizing a quartz reactor inserted in a furnace. Different quantities of a commercial catalyst, belonging to the group of zeolite systems and containing, in particular, Y zeolite as active phase, at equilibrium (depending on the necessary catalyst/feedstock ratio, indicated as Cat/Oil) are charged, diluted with quartz microspheres, into the reactor and pre-heated under a nitrogen flow. The feedstock, whose characteristics are indicated in table 1, is fed under a controlled velocity.

TABLE 1

| Density 15° C. | 0.9003 | kg/l |
|---|---|---|
| Carbonaceous residue | 3.1% | w |
| Refractive index 75° C. | 1.4810 | |
| Sulphur | 0.45% | w |
| ASTM-D6352 [° C.] | | |
| IBP/5% | 218/305 | |
| 10%/30% | 341/410 | |
| 50%/70% | 454/507 | |
| 90%/FBP | 602/713 | |
| Nitrogen | 0.14% | w |
| Basic nitrogen | 967 | ppm |
| Iron | 1.5 | ppm |
| Nickel | 3.5 | ppm |
| Copper | 0.3 | ppm |
| Sodium | 4.8 | ppm |
| Vanadium | 3.6 | ppm |

At the end of the injection the catalyst is stripped using a flow of nitrogen to remove the hydrocarbons adsorbed. The gaseous products are classified by the water displacement and analyzed by gas-chromatography. The liquid products, collected in a container cooled with dry ice, are quantified by weighing and analyzed by gas-chromatography (ASTM-D2887). The exhausted catalyst, discharged from the reactor, is analyzed to determine the quantity of coke deposited. The operative conditions are summarized in the following table:

TABLE 2

| Reaction temperature | 560° C. | |
|---|---|---|
| Feedstock (oil) | 1.5 | gr. |
| Injection time | 12 | sec |

| | |
|---|---|
| Cat/oil | from 1.5 to 2.5 |

The performances of ERS-10 as additive were evaluated by mixing 3.0% by weight of ERS-10 with the catalyst at equilibrium and compared with that of the catalyst as such:
Base case: commercial catalyst based on zeolite Y and feedstock of tab. 1
Example with ERS-10: Base case+3.0% ERS-10

Both for the Base case and the example in which ERS-10 is used to obtain the selectivity curves to allow iso-parameter comparisons, various catalyst/feedstock ratios were used.

Table 3 reports the results expressed in terms of conversion, by comparing the base case with the case with the addition of the ERS-10 additive, operating at iso cat/oil (2.0) and T of 560° C.:

TABLE 3

| | Base case | Ex. with ERS-10 |
|---|---|---|
| Cat/Oil | 2 | 2 |
| Conversion | 60.8 | 71.2 |
| Fuel gas | 2.2 | 2.4 |
| LPG | 17.4 | 19.1 |
| Gasoline | 37.1 | 45.2 |
| LCO (370−) | 21.6 | 18.3 |
| HCO (370+) | 17.5 | 10.4 |
| Coke | 4.0 | 4.4 |
| Bottom cracking | 1.2 | 1.8 |

As can be observed, the addition of the additive caused a considerable increase in the conversion (yield to gasoline/LPG) and a significant increase in the bottom cracking, i.e. the ratio between LCO and HCO.

1) A process for the cracking of hydrocarbon mixtures, characterized in that it is carried out in the presence of a catalyst containing ERS-10 zeolite.

2) The process according to claim 1, wherein the catalyst contains two different components: (a) a component containing one or more cracking catalysts and (b) a component containing ERS-10 zeolite.

3) The process according to claim 1 or 2, characterized in that it is a fluid catalytic cracking process.

4) The process according to one or more of the previous claims, carried out in the presence of a catalyst comprising:
a) a first component containing one or more catalysts selected from zeolites, amorphous cracking catalysts based on inorganic oxides and crystalline cracking catalysts based on inorganic oxides
b) a second component containing an ERS-10 zeolite.

5) The process according to claim 2, 3 or 4, wherein the catalyst or mixture of catalysts contained in component (a) are dispersed in a matrix of inorganic oxide.

6) The process according to claim 4, wherein, in component (a) the amorphous catalysts are selected from silico-titania, silico-alumina-magnesia, silico-alumina-zirconia, silico-magnesia-zirconia.

7) The process according to claim 4, wherein, in component (a) the non-zeolitic crystalline catalyst is a crystalline silico-alumina.

8) The process according to claim 4, wherein, in component (a) the zeolites are large-pore zeolites.

9) The process according to claim 8, wherein the zeolite is selected from Y zeolite, L zeolite, Omega, Beta and Mordenite.

10) The process according to claim 9, wherein the zeolite is Y zeolite.

11) The process according to claim 4, wherein in component (a) the zeolites are in bound form with a binder.

12) The process according to claim 11, wherein the binder is selected from silica, alumina, silico-alumina, clay, silico-zirconia, silico-magnesia, aluminium phosphate or mixtures thereof.

13) The process according to claim 1, 2, 3 or 4, wherein the ERS-10 zeolite is co-crystallized with Mordenite or ZSM-12 zeolite.

14) The process according to claim 1, 2, 3 or 4, wherein the ERS-10 zeolite contains accessory phases of NON, EUO and NES zeolites.

15) The process according to claim 1, 2, 3 or 4, 12 or 13, wherein the ERS-10 zeolite is used in a bound form.

16) The process according to claim 15, wherein the zeolite is bound and in the form of microspheres.

17) The process according to claim 15 or 16, wherein the binder is selected from silica, amorphous silica-alumina, alumina or mixtures thereof.

18) The process according to claim 2, 3 or 4, wherein in component (b) the ERS-10 zeolite is in a bound form with a binder in a quantity of 5 to 90% with respect to the total weight of said component.

19) The process according to claim 2, 3 or 4, wherein the ERS-10 zeolite is present in a quantity of 1 to 10% with respect to the weight of the catalyst contained in component (a).

20) The process according to one or more of the previous claims, carried out at a temperature ranging from 400 to 650° C.

21) The process according to one or more of the previous claims, carried out at a pressure varying from 1 to 5 bar.

22) A catalyst containing two different components: (a) a component containing one or more cracking catalysts and (b) a component containing ERS-10 zeolite.

23) The catalyst according to claim 22, comprising:
a) a first component containing one or more catalysts selected from zeolites, amorphous cracking catalysts based on inorganic oxides and crystalline cracking catalysts, based on inorganic oxides
b) a second component containing an ERS-10 zeolite.

24) The catalyst according to claim 22 or 23, wherein the ERS-10 zeolite is co-crystallized with mordenite or ZSM-12 zeolite.

25) The catalyst claim 22 or 23, wherein the ERS-10 zeolite contains accessory phases of NON, EUO and NES zeolites.

26) The catalyst according to one or more of the claims from 22 to 25, wherein the ERS-10 zeolite is used in bound form.

27) The catalyst according to claim 26, wherein the zeolite is bound and in the form of microspheres.

28) The catalyst according to claim 26 or 27, wherein the binder is selected from silica, amorphous silica-alumina, alumina or mixtures thereof.

29) The catalyst according to claim 22 or 23, wherein in component (b) the ERS-10 zeolite is in bound form with a binder in a quantity of 5 to 90% with respect to the overall weight of said component.

30) The catalyst according to claim 22 or 23, wherein the ERS-10 zeolite is present in a quantity ranging from 1 to 10% with respect to the weight of the catalyst contained in component (a).

31) The catalyst according to one or more of the claims from 22 to 30, wherein the cracking catalyst is a fluid catalytic cracking catalyst.

32) A process for preparing the catalyst according to claim 22, 23 or 31 comprising the mechanical mixing of components (a) and (b).

33) The process for preparing the catalyst according to claim 22, 23 or 31 comprising subjecting the ERS-10 zeolite and the catalyst contained in component (a) to contemporaneous binding.

34) A process for preparing in situ the catalyst of claim 22, 23 or 31 comprising the addition of component (b) to component (a) already present in the cracking process, in any point of the process itself.

35) Use of ERS-10 zeolite as additive in cracking processes.

36) Use of ERS-10 zeolite according to claim 35, wherein the cracking process is a fluid catalytic cracking process.
